(19) United States
(12) Patent Application Publication
(10) Pub. No.: US 2025/0319897 A1
(43) Pub. Date: Oct. 16, 2025

(54) HYBRID TRAFFIC FLOW TESTING METHOD AND SYSTEM BASED ON DIGITAL TWIN AND VIRTUAL-PHYSICAL INTEGRATION

(71) Applicant: Chang'an University, Xi'an (CN)

(72) Inventors: Haigen Min, Xi'an (CN); Xia Wu, Xi'an (CN); Xiangmo Zhao, Xi'an (CN); Yong Liu, Xi'an (CN); Sen Xia, Xi'an (CN); Wuqi Wang, Xi'an (CN); Shixiang Chen, Xi'an (CN); Shengsheng Xing, Xi'an (CN); Lisha Chen, Xi'an (CN)

(21) Appl. No.: 19/174,039

(22) Filed: Apr. 9, 2025

(30) Foreign Application Priority Data
Apr. 10, 2024 (CN) 2024104296037

(51) Int. Cl. B60W 60/00; G06V 10/82; G06V 20/58; H04W 4/40

(52) U.S. Cl. CPC B60W 60/0011; G06V 10/82; G06V 20/58; H04W 4/40

(57) ABSTRACT

A hybrid traffic flow testing method and system based on digital twin and virtual-physical integration includes steps as follows. Data of a realistic testing site is collected, and a virtual scene is created based on the digital twin, interactions between a realistic environment and a virtual environment are set up to achieve a system configuration of a system based on the virtual-physical integration. Virtual human-driven vehicles are generated based on a data set of the system configuration, and realistic human-driven vehicles are generated based on data collected by driving simulators operated by realistic human drivers. Human-driven vehicles are formed by combining the virtual and realistic human-driven vehicles, and status and location information of the human-driven vehicles are acquired. A set of sensing, positioning, planning, control, and V2X communication methods are set up based on the status and the location information for CAVs, thereby achieving autonomous driving.

### CROSS-REFERENCE TO RELATED APPLICATION

This application claims priority to Chinese patent application No. CN 202410429603.7, filed to China National Intellectual Property Administration (CNIPA) on Apr. 10, 2024, which is herein incorporated by reference in its entirety.

### TECHNICAL FIELD

The disclosure relates to the technical field of autonomous driving test, and particularly to a hybrid traffic flow testing method and system based on digital twin and virtual-physical integration.

### BACKGROUND

Before autonomous driving vehicles are truly commercialized, extensive road tests are needed to meet commercial requirements. However, traditional road tests consume significant human and material resources, risk vehicle damage and personnel injury, and struggle to ensure cost-effectiveness and safety. With advances in simulation technology and improvements in software and hardware performance, autonomous driving simulation has become crucial for testing performance of an autonomous driving system. Large-scale autonomous driving simulation relies on a high-performance computing platform, using scenarios and vehicle configurations from simulators to conduct closed-loop tests. This makes research and development of the autonomous driving more efficient and economical. Yet, single simulation tests lack authenticity, hindering commercial application.

The autonomous driving test platform for the integration of virtual and physical testing is a primary tool for such testing. It places a real autonomous driving vehicle in an actual road environment. During the testing, the platform injects virtual traffic objects into the autonomous driving system to achieve the integration of virtual and physical testing.

Compared to individual the real-vehicle test and the simulation test, the integration of virtual and physical testing offers more flexible scenario configuration, higher scenario coverage, and safer testing. It also enables automatic and cloud-accelerated testing, improving efficiency and reducing costs. Additionally, with digital scenarios based on the digital twin, the feasibility and authenticity of the tests are enhanced.

### SUMMARY

The disclosure provides a hybrid traffic flow testing method and a hybrid traffic flow testing system based on digital twin and virtual-physical integration to solve the problems in the related art.

To achieve above purpose, the technical solutions of a hybrid traffic flow testing method based on digital twin and virtual-physical integration in the disclosure are as follows.

Data of a realistic testing site is collected, and a virtual scene is created based on the digital twin, interactions between a realistic environment and a virtual environment are set up to achieve a system configuration of a system based on the virtual-physical integration. Virtual human-driven vehicles with different styles are generated based on a data set of the system configuration, and realistic human-driven vehicles with different styles are generated based on data collected by driving simulators operated by realistic human drivers. Human-driven vehicles with different driving styles are formed by combining a portion of the virtual human-driven vehicles and a portion of the realistic human-driven vehicles, and status information and location information of the human-driven vehicles with different driving styles are acquired. A set of sensing, positioning, planning, control, and vehicle to everything (V2X) communication methods are set up based on the status information and the location information of the human-driven vehicles with different driving styles for connected and automated vehicles (CAVs), and autonomous driving of the CAVs in the system is performed based on the of the set of sensing, positioning, planning, control, and V2X communication methods.

In an embodiment, the collecting data of a realistic testing site and creating a virtual scene based on the digital twin, and setting up interactions between a realistic environment and a virtual environment to achieve a system configuration based on the virtual-physical integration includes steps as follows.

The data of the realistic testing site is collected from a realistic autonomous driving test site, a point cloud map of the realistic testing site is constructed, and a three-dimensional (3D) reconstructed scene is created and a basic construction of the virtual environment is completed based on the digital twin. Appearances, physical models, and skeletons of realistic vehicles are imported into the virtual environment, a mapping of the realistic vehicles in the virtual environment is generated, a state of the realistic vehicles in the virtual environment is updated by transmitting data of status information and control information of the realistic vehicles in the realistic environment to the virtual environment, and the CAVs are modeled and synchronously transmitted to a realistic scene, thereby controlling the realistic vehicles in the realistic scene. An edition of the virtual scene is completed by virtual traffic participants using a testing device based on the virtual-physical integration, and postures of realistic traffic participants are transmitted in real-time into the system by wearable devices. Decision-making, planning, and control functions in the virtual environment are executed based on the status information, the control information, and virtual scene information of the realistic vehicles by the virtual human-driven vehicles. Status information and control information of the virtual human-driven vehicles are transmitted to a Kafka server based on a data exchange protocol, followed by transmitting the status information and the control information of the virtual human-driven vehicles to the realistic human-driven vehicles through the Kafka server. The control information of the virtual human-driven vehicles in the realistic environment is executed by the realistic vehicles.

In an embodiment, the generating virtual human-driven vehicles with different styles based on a data set of the system configuration, and generating realistic human-driven vehicles with different styles based on data collected by driving simulators operated by realistic human drivers; forming human-driven vehicles with different driving styles by combining a portion of the virtual human-driven vehicles and a portion of the realistic human-driven vehicles; and acquiring status information and location information of the human-driven vehicles with different driving styles includes steps as follows.

Cleaning and denoising are performed on the data set of the system and the data collected by the driving simulators operated by realistic human drivers to obtain processed data, a cluster analysis is performed on the processed data to classify the driving styles into a conservative style, a conventional style, and an aggressive style, and human driver models with the different driving styles are established. The human-driven vehicles with the different driving styles are generated by using a simulation of urban mobility (SUMO), then a normal distribution is used to calibrate various parameters for the human-driven vehicles with the different driving styles, which is expressed as follows:

$$f ( x ) = \frac{1}{\sqrt{2 π} σ} exp ( - \frac{{( x - μ )}^{2}}{2 {σ}^{2}} )$$

where μ represents a mathematical expectation, σ² represents a variance, and X represents a normal distribution with obedience parameters of μ and σ. A state vector X is used to represent parameters that need to be calibrated for the human-driven vehicles with the different driving styles, the different driving styles are classified based on the normal distribution with obedience parameters, to thereby obtaining the virtual human-driven vehicles with the different driving styles. Simultaneously, a part of the realistic human drivers is driven by the realistic human drivers through the simulator to thereby generate the realistic human-driven vehicles, and the virtual human-driven vehicles and the realistic human-driven vehicles together form the human-driven vehicles with the different driving styles under different penetration rates, to thereby obtain the status information and the location information of the human-driven vehicles with the different driving styles.

In an embodiment, the positioning method includes steps as follows.

A state vector of a Kalman filter including navigation state errors and tor errors is defined, which is expressed as follows:

$$δ x ( t ) = {[ {φ}^{T} , {a}_{a}^{T} , {a}_{g}^{T} , {b}_{a}^{T} , {b}_{g}^{T} , {( δ {r}^{n} )}^{T} , {( δ {v}^{n} )}^{T} ]}^{T}$$

where δx(t) represents the state vector of the Kalman filter, T represents an transpose operation, t represents time, φ represents an error vector of an attitude, aₐ represents an error vector of a scale factor of an accelerometer, a_{g} represents an error vector of a scale factor of a gyroscope, bₐ represents a zero-bias error vector of a tri-axis accelerometer bias, b_{g} represents a zero-bias error vector of a tri-axis gyroscope bias, δrⁿ represents an error vector of an inertial navigation position, and δvⁿ represents an error vector of an inertial navigation velocity.

A continuous time differential equation of the state vector of the Kalman filter is obtained, then error differential equations of a position, a velocity, and an attitude are obtained by differentiating vector components of the state vector of the Kalman filter with respect to the time t. A first order Gauss-Markov process is performed to model the error vector of the scale factor of the accelerometer, the error vector of the scale factor of the gyroscope, the zero-bias error vector of the tri-axis accelerometer and the zero-bias error vector of the tri-axis gyroscope, and a noise vector and matrix of the system in continuous time from the continuous time differential equation of the state vector of the Kalman filter are derived, which are expressed as follows:

$$w ( t ) = {[ {w}_{v}^{T} , {w}_{φ}^{T} , {w}_{gb}^{T} , {w}_{ab}^{T} , {w}_{ga}^{T} , {w}_{a a}^{T} ]}^{T}$$

$$E [ x ( t ) {w}^{T} ( τ ) ] = q ( t ) δ ( t - τ )$$

where

$${w}_{v}^{T} and {w}_{φ}^{T}$$

represent measurement white noise of the accelerometer and measurement white noise of the gyroscope, respectively; and

$${w}_{gb}^{T} , {w}_{ab}^{T} , {w}_{ga}^{T} and {w}_{aa}^{T}$$

represent driving white noise of a modeled zero-bias error vector of the tri-axis gyroscope, driving white noise of a modeled zero-bias error vector of the tri-axis accelerometer, driving white noise of a modeled error vector of the scale factor of the gyroscope, and driving white noise of a modeled error vector of the scale factor of the accelerometer.

A state equation of a discretized system is obtained based on a basic equation of a discrete-time Kalman filter, which is expressed as follows:

$$δ {x}_{k} = {Φ}_{k / k - 1} δ {x}_{k - 1} + {w}_{k - 1}$$

$$where$$

$${Φ}_{\frac{k}{k} - 1} = exp ( {\int }_{{t}_{k - 1}}^{{t}_{k}} F ( t ) dt )$$

$${w}_{k - 1} = {\int }_{{t}_{k - 1}}^{{t}_{k}} {Φ}_{k / t} G ( t ) w ( t ) d t$$

the discretized system meets requirements of the basic equation of the discrete time Kalman filter, and the discretized system is configured to solve a global navigation satellite system and inertial measurement unit (GNSS/IMU) integrated navigation problem. The discretized system is configured to perform filtering on sequential data from the GNSS including latitude lat and longitude lon, data from the IMU including angular velocities of ωₓ, ω_{y} and ω_{z} and accelerations of aₓ, a_{y} and a_{z} along x, y, and z axes of each human-driven vehicle, respectively; and the discretized system is configured to output data of each human-driven vehicle to the CAVs.

In an embodiment, the sensing method includes steps as follows.

Objects in a surrounding of each human-driven vehicle are detected by using a you only look once version 5 (YOLOv5). Simultaneously, in response to a collaborative sensing application of each human-driven vehicle being activated, then both raw sensing data and processed sensing data are sent to the CAVs nearby the human-driven vehicle through a V2X communication module, thereby achieving collaborative sensing of the CAVs.

In an embodiment, the planning method includes steps as follows.

An optimal global planning path is created according to a start point and an end point of each human-driven vehicle by using an A* algorithm with a Euclidean distance as a heuristic algorithm. Then, during driving of each human-driven vehicle, a smooth local planning path of each human-driven vehicle is generated by using a cubic spline interpolation, the smooth local planning path includes a list of x and y coordinates of returning path, a list of curvatures of the returning path, and a list of yaw angles of the returning path. After the generating, the lists of the returning path are transmitted to a control end to create commands of braking, acceleration, and steering.

In an embodiment, the control method includes steps as follows.

Possible disturbances during movements of the human-driven vehicles are compensated by using a model predictive control (MPC). And during operations of the CAVs, values of corresponding throttles, brakes, and steering angles are generated based on information of planning path in real time by using an equal vehicle headway control model.

In an embodiment, the V2X communication method includes steps as follows.

The current status of each human-driven vehicle is transmitted in real time, the CAVs around each human-driven vehicle are communicate with each human-driven vehicle in real-time based on a V2X communication module. Decisions are made at a current time by a decision planning module based on the current status of each human-driven vehicle, and collaborative driving between the human-driven vehicles are carried out.

In an embodiment, the performing autonomous driving of the CAVs in the system includes steps as follow.

The autonomous driving is achieved in real time through sensing, positioning, planning, control, and V2X communication modules. The virtual environment interacts with the realistic environment in real time, thereby realizing a complete set of autonomous driving development and testing that combines the virtual environment and the realistic environment on the realistic testing site.

The disclosure also provides a hybrid traffic flow testing system based on digital twin and virtual-physical integration.

The hybrid traffic flow testing system includes a data configuration module, a data collection module, and a data analysis module. The data configuration module is configured to collect data of a realistic testing site and create a virtual scene based on the digital twin, and set up interactions between a realistic environment and a virtual environment achieve a system configuration of a system based on the virtual-physical integration. The data collection module is configured to generate virtual human-driven vehicles with different styles based on a data set of the system configuration, and generate realistic human-driven vehicles with different styles based on data collected by driving simulators operated by realistic human drivers; wherein human-driven vehicles with different driving styles are formed by combining a portion of the virtual human-driven vehicles and a portion of the realistic human-driven vehicles, and the data collection module is configured to acquire status information and location information of the human-driven vehicles with different driving styles. The data analysis module is configured to set up a set of sensing, positioning, planning, control, and V2X communication methods for CAVs based on the status information and the location information of the human-driven vehicles with different driving styles, and perform autonomous driving of the CAVs in the system based on the of the set of sensing, positioning, planning, control, and V2X communication methods.

The beneficial effects of the disclosure are as follows.

The method can add realistic vehicles to enhance the reality of the testing process, set up a full suite of sensing, positioning, planning, control, and V2X communication modules for the CAVs, establish the virtual human-driven vehicles with different driving styles, import the realistic human-driven vehicles operated by the realistic drivers through the driving simulators, significantly reduce the cost and enhance the safety of large scale testing of the realistic vehicles, and achieve the integration of realistic vehicle dynamics, mixed traffic flow simulation, and various complex virtual traffic scenarios for a more authentic testing environment.

### BRIEF DESCRIPTION OF DRAWINGS

In order to provide a clearer explanation of the embodiments of the disclosure or the technical solutions in the related art, a brief introduction will be given to the attached drawings required for the description of the embodiments or the related art. It is apparent that the attached drawings described below are only some embodiments of the disclosure. For those skilled in the art, other drawings can be obtained based on these drawings without creative labor.

FIG. 1 illustrates a step flowchart of a hybrid traffic flow testing method based digital twin and virtual-physical integration of the disclosure.

FIG. 2 illustrates a structural block diagram of a hybrid traffic flow testing system based on the digital twin and virtual-physical integration of the disclosure.

FIG. 3 illustrates an infrastructure scene of a realistic testing site in an embodiment of the disclosure.

FIG. 4 illustrates a digital twin modeling of a realistic autonomous driving test site in the embodiment of the disclosure.

FIG. 5 illustrates an interaction protocol flow of a system of the digital twin and virtual-physical integration in the embodiment of the disclosure.

FIG. 6 illustrates a process of generating models of human drivers with different driving styles in the embodiment of the disclosure.

FIG. 7 illustrates a framework of an overall testing method for the hybrid traffic flow testing system in the embodiment of the disclosure.

FIG. 8 illustrates a model predictive control framework adopted for CAVs in the embodiment of the disclosure.

### DETAILED DESCRIPTION OF EMBODIMENTS

In order to further illustrate the technical solutions and effects adopted by the disclosure to achieve the predetermined objectives, the following, in conjunction with the attached drawings and specific embodiments, provides a detailed description of a hybrid traffic flow testing method and system based digital twin and virtual-physical integration proposed in accordance with the disclosure, including its specific implementation, structure, features, and effects. In the following explanation, “an embodiment” or “another embodiment” may not necessarily refer to the same embodiment. In addition, specific features, structures, or characteristics in one or more embodiments may be combined in any suitable form.

Unless otherwise defined, all technical and scientific terms used in this article have the same meanings as those commonly understood by those skilled in the art belonging to the disclosure.

The specific scheme of a hybrid traffic flow testing method and system based on digital twin and virtual-physical integration by the disclosure will be described below in conjunction with the attached drawings.

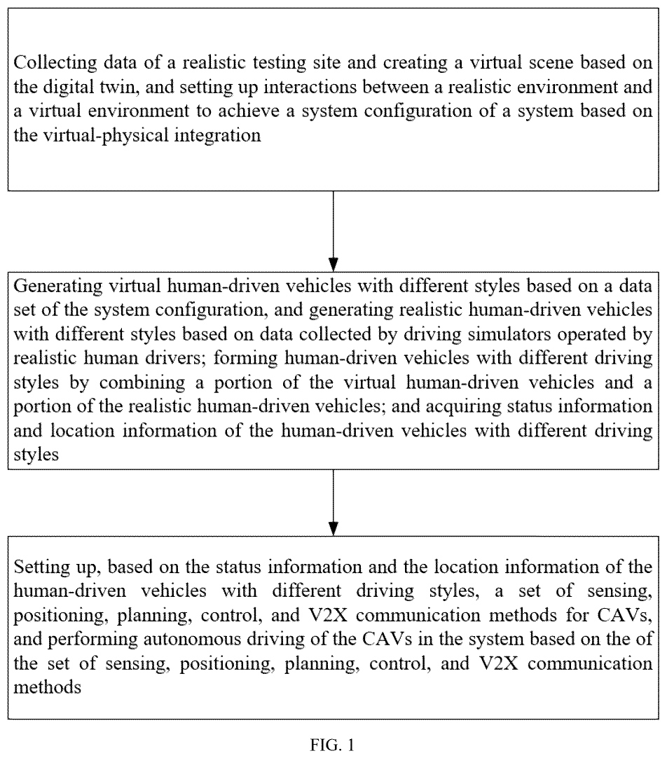

As shown in FIG. 1, which illustrates a step flowchart of the hybrid traffic flow testing method based on digital twin and virtual-physical integration of the disclosure, and the hybrid traffic flow testing method includes steps as follows.

In a first step, the hybrid traffic flow is achieved based on digital twin and virtual-physical integration: joint simulation between a car learning to act (CARLA) and a simulation of urban mobility (SUMO) can be achieved based on the CARLA and the SUMO sharing the same Opendrive road geometry file and road networks of the CARLA and the SUMO perfectly matched.

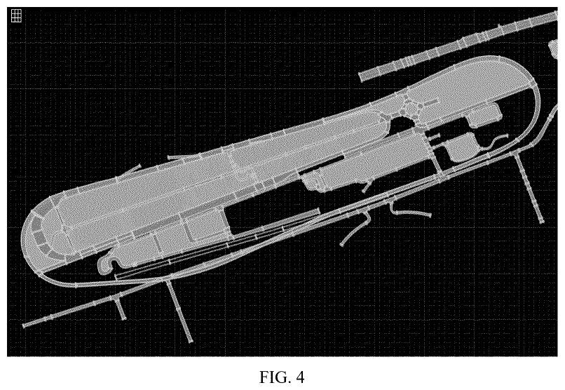

Based on a benchmark map of an autonomous driving test site of the CAVs, as shown in FIG. 3, this site is a cutting-edge, fully-functional test bed for collaborative vehicle-road autonomous driving, capable of effectively verifying various scenarios. By collecting site data from the autonomous driving test site, a point cloud map is constructed. In a RoadRunner, formatted roads based on OpenDrive are generated, as shown in FIG. 4. This completes the 3D reconstruction scene of a realistic test site, along with relevant environmental and road information. Finally, the needed xodr and fbx format maps for CARLA, as well as the SUMO road grid (net.xml) format map, are exported to achieve high-precision matching between the simulation scene and the realistic scene, thus finishing the basic construction of the virtual environment in the digital twin.

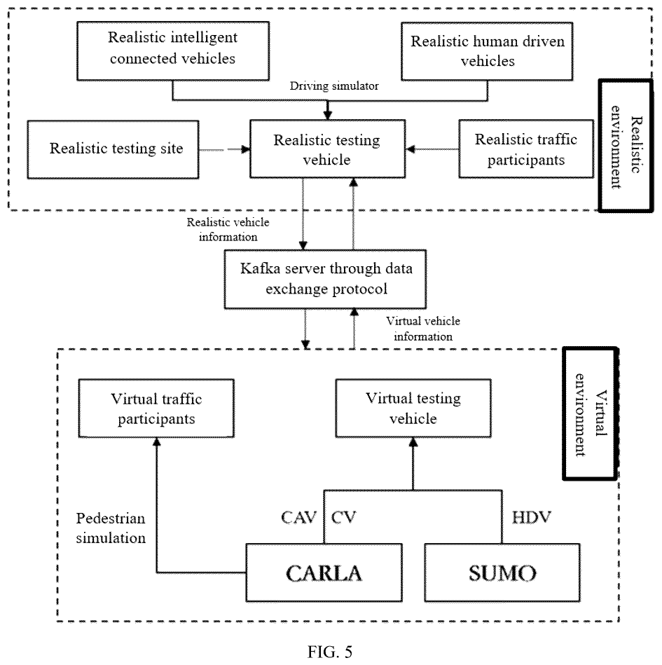

Furthermore, appearances, physical models, and skeletons of the realistic vehicles are imported into the virtual environment to create a virtual representation of the realistic vehicles. An integrated interaction architecture of a system based on digital twin and virtual-physical integration, as shown in FIG. 5, the system uses a Kafka messaging system for data exchange between realistic and virtual vehicles. The realistic tested vehicles sensory traffic participants and road environments in the realistic environments, and the system transmits status information and control information of the realistic testing vehicle to Kafka server through a data exchange protocol based on addresses and topics of the Kafka server. Kafka users subscribe to Kafka server messages, which includes a message list as follows:

| field | meaning |
|---|---|
| timestamp | time stamp |
| id | vehicle ID |
| vehicleType | vehicle type |
| originalColor | vehicle color |
| longitude | longitude of the vehicle's location |
| latitude | latitude of the vehicle's location |
| altitude | altitude at which vehicle is located |
| speed | real time vehicle speed |
| acc | real time acceleration of vehicles |
| course Angle | real time steering angle of the vehicle |
| picLicense | registration number |
| baseStationSource | Base station where the vehicle is located |

Furthermore, the message list is transmitted to the virtual environment, and at each time step, the incoming messages are continuously synchronized to update the status of the vehicles, the CAVs are modeled, and then synchronously transmitted to the realistic scene for decision control of the realistic vehicles.

An edition of the virtual scene is completed by virtual traffic participants using a testing device based on the virtual-physical integration, the virtual scene information is transmitted to the Kafka server through the data exchange protocol, and the Kafka server then transmits it to the virtual testing vehicle.

Postures of realistic traffic participants are transmitted in real-time into the system by wearable devices, thereby achieving system modeling for the realistic traffic participants.

Decision-making, planning, and control functions in the virtual environment are executed based on the status information, the control information, and virtual scene information of the realistic vehicles by the virtual human-driven vehicles. Status information and control information of the virtual human-driven vehicles are transmitted to the Kafka server based on the data exchange protocol, followed by transmitting the status information and the control information of the virtual human-driven vehicles to the realistic human-driven vehicles through the Kafka server. The control information of the virtual human-driven vehicles in the realistic environment is executed by the realistic vehicles.

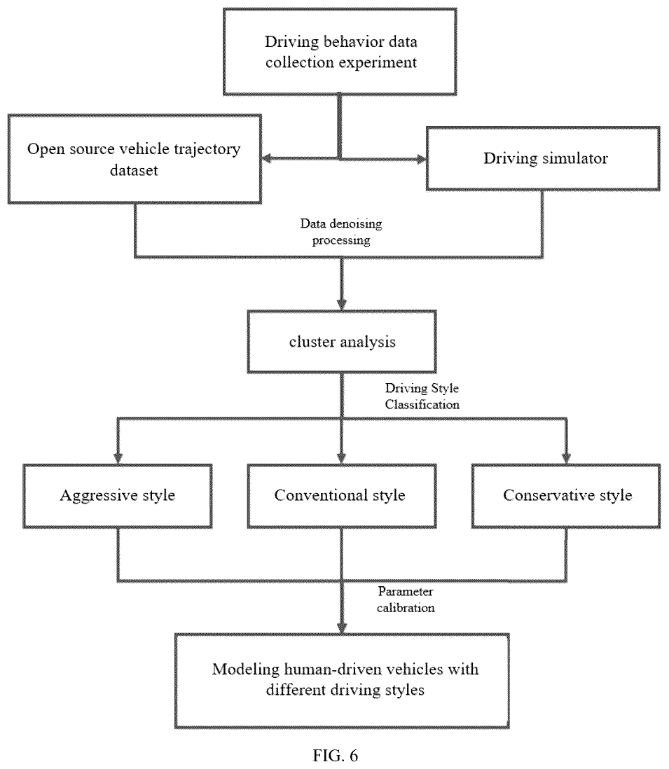

In a second step, human-driven vehicles with different driving styles are set up. As shown in FIG. 6, cleaning and denoising are performed on the data set of the system and the data collected by the driving simulators operated by realistic human drivers to obtain processed data, a cluster analysis is performed on the processed data to classify the driving styles into a conservative style, a conventional style, and an aggressive style, and human driver models with the different driving styles are established. The human-driven vehicles with the different driving styles are generated by using the SUMO, then a normal distribution is used to calibrate various corresponding parameters for the human-driven vehicles with the different driving styles, which is expressed as follows:

$$f ( x ) = \frac{1}{\sqrt{2 π} σ} exp ( - \frac{{( x - μ )}^{2}}{2 {σ}^{2}} )$$

where μ represents a mathematical expectation, σ² represents a variance, and X represents a normal distribution with obedience parameters of μ and σ.

In an embodiment, A state vector X is used to represent parameters that need to be calibrated for the human-driven vehicles with the different driving styles, including eight components:

$$χ = [ Td , Dd , Acc , Dce , Mv , Md , Fol , Cl ]$$

where Td represents a time headway that a human-driven vehicle needs to maintain, with a unit of second; Dd represents a distance between vehicles that need to be maintained for the human-driven vehicle, with a unit of meter; Acc and Dce represent an acceleration and a deceleration during a driving process of the human-driven vehicle, respectively, with a unit of meter per second squared (m/s²); Mv represents a maximum speed during the driving process of the human-driven vehicle, with a unit of meter per second (m/s); Md represents a maximum deceleration of the human-driven vehicle in emergency situations, with a unit of m/s²; Fol and Cl represent parameter settings for the following and lane changing models of the human-driven vehicle.

The above normal distribution formula is used to divide the eight components of the state vector X according to the type of human-driven vehicle (the conservative style, the conventional style, and the aggressive style), and an upper limit parameter of each component is limited to keep each component within an appropriate range according to the vehicle types. The different variables in the state vector X are divided into driver style to obtain virtual human-driven vehicles with different driving styles.

Simultaneously, a part of the realistic human drivers is driven by the realistic human drivers through the simulator to, thereby generate the realistic human-driven vehicles, and the virtual human-driven vehicles and the realistic human-driven vehicles together form the human-driven vehicles with the different driving styles under different penetration rates, to thereby obtain the status information and the location information of the human-driven vehicles with the different driving styles.

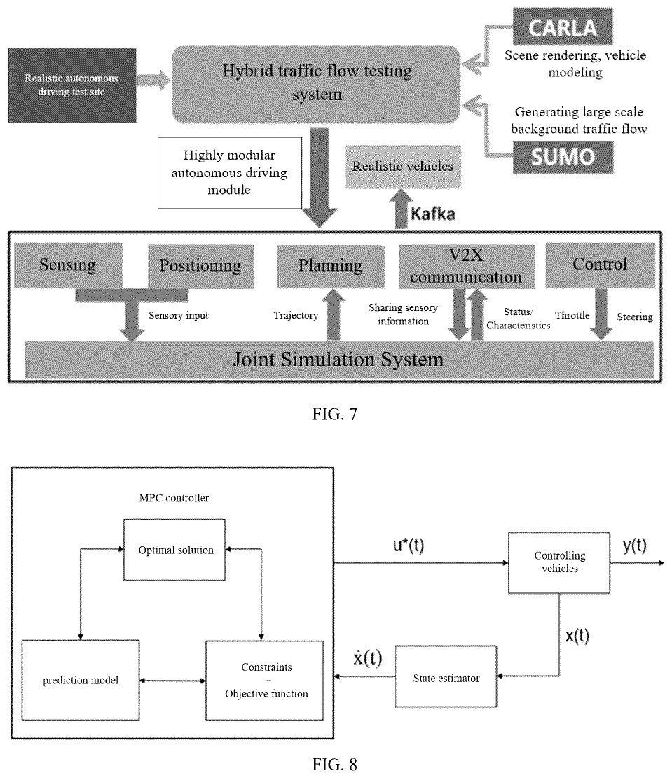

In a third step, modeling and control for CAVs are achieved. Sensing, positioning, planning, control, and V2X communication methods are used. Based on these basic modules (sensing, positioning, planning, control and V2X communication modules), the disclosure can achieve autonomous driving of the realistic vehicles and support a series of common collaborative driving tests. The overall framework is shown in FIG. 7.

Specifically, the positioning method includes steps as follows.

The Kalman filter positioning method that integrates GNSS and IMU is used, a discrete-time system error state model is established, and a linear observation equation for the error state is constructed. Then, the basic equation of Kalman filter is used for combined navigation solution.

A state vector of a Kalman filter including navigation state errors and sensor errors is defined, which is expressed as follows:

$$δ x ( t ) = {[ {φ}^{T} , {a}_{a}^{T} , {a}_{g}^{T} , {b}_{a}^{T} , {b}_{g}^{T} , {( δ {r}^{n} )}^{T} , {( δ {v}^{n} )}^{T} ]}^{T}$$

where δx(t) represents the state vector of the Kalman filter, T represents an transpose operation, t represents time, φ represents an error vector of an attitude, aₐ represents an error vector of a scale factor of an accelerometer, a_{g} represents an error vector of a scale factor of a gyroscope, bₐ represents a zero-bias error vector of a tri-axis accelerometer bias, b_{g} represents a zero-bias error vector of a tri-axis gyroscope bias, δrⁿ represents an error vector of an inertial navigation position, and δvⁿ represents an error vector of an inertial navigation velocity.

A continuous time differential equation of δx(t) is obtained, which is expressed as follows:

$$δ \dot{x} ( i ) = F ( t ) δ x ( t ) + G ( t ) w ( t )$$

where δx(t) represents a derivative of the state vector δx(t), F(t) represents a transition matrix, which is configured to describe characteristics of internal state transitions in the system, G(t) represents a noise driven matrix, which is configured to characterize a impact of noise on state variables, and w(t) represents a system noise vector.

δx(t) is differentiated with respect to a time t to obtain the error differential equations for position, velocity, and attitude expressed as follows:

$$δ {\dot{r}}^{n} = - {w}_{e n}^{n} * δ {r}^{n} + δ θ * {v}^{n} + δ {v}^{n}$$

$$δ {\dot{v}}^{n} = {C}_{b}^{n} δ {f}^{b} + {f}^{n} * φ - ( 2 {w}_{i e}^{n} + {w}_{e n}^{n} ) * δ {v}^{n} + {v}^{n} * ( 2 δ {w}_{i e}^{n} + δ {w}_{e n}^{n} ) + δ {g}_{p}^{n}$$

$$\dot{φ} = - {w}_{i n}^{n} * φ + δ {w}_{i n}^{n} - δ {w}_{i b}^{n}$$

where

$$δ {\dot{r}}^{n}$$

represents taking a derivative of the navigation state errors of the state vector

$$δ x ( t ) , - {w}_{e n}^{n}$$

represents a negative component of Earth's rotational angular velocity in a n-system, δθ*vⁿ represents a product of attitude error angle and carrier velocity in the n-system,

$$δ {\dot{v}}^{n}$$

represents taking a derivative of an inertial velocity error vector

$$δ {r}^{n} , {C}_{b}^{n}$$

represents a coordinate transformation matrix from a carrier coordinate b-system to a carrier coordinate n-system, δƒ^{b} represents a measurement error of the accelerometer in the b-system, ƒⁿ represents an acceleration of the n-system download body relative to an inertial Earth's space, φ represents an error vector of an attitude,

$${w}_{i e}^{n}$$

represents a component of the Earth's rotational angular velocity in the n-system,

$$δ {w}_{i e}^{n} and δ {w}_{e n}^{n}$$

represent measurement errors of the Earth's rotational angular velocity and the Earth's relative carrier angular velocity, respectively,

$$δ {g}_{p}^{n}$$

represents a gravity error in the n-system, φ in

$$\dot{φ} = - {w}_{i n}^{n} * φ + δ {w}_{i n}^{n} - δ {w}_{i b}^{n}$$

represents a time rate of change of attitude error angle,

$${w}_{i n}^{n}$$

represents a component of the angular velocity of the carrier relative to the inertial coordinate system in the n-system,

$$δ {w}_{i n}^{n}$$

represents a measurement error of the angular velocity of the carrier relative to an inertial system,

$$δ {w}_{i b}^{n}$$

represents a gyroscope measurement error.

A first order Gauss-Markov process is performed to model the error vector of the scale factor of the accelerometer, the error vector of the scale factor of the gyroscope, the zero-bias error vector of the tri-axis accelerometer and the zero-bias error vector of the tri-axis gyroscope, which is expressed below:

$${\dot{a}}_{a} ( t ) = - \frac{1}{{T}_{a s}} {a}_{a} ( t ) + {w}_{a s} ( t )$$

$${\dot{a}}_{g} ( t ) = - \frac{1}{{T}_{g s}} {a}_{g} ( t ) + {w}_{g s} ( t )$$

$${\dot{b}}_{a} ( t ) = - \frac{1}{{T}_{a b}} {b}_{a} ( t ) + {w}_{a b} ( t )$$

$${\dot{b}}_{g} ( t ) = - \frac{1}{{T}_{g b}} {b}_{g} ( t ) + {w}_{g b} ( t )$$

where Tₐₛ, T_{gs}, T_{ab} and T_{gb} represent correlation times of the first order Gauss-Markov process; and wₐₛ(t), w_{gs}(t), w_{ab}(t) and w_{gb}(t) represent driving white noise of the first order Gauss-Markov process, \dot{a}ₐ(t) represents a time rate of change of a scale factor error vector aₐ(t) of accelerometer, \dot{a}_{g}(t) represents a time rate of change of a scale factor error vector a_{g}(t) of gyroscope, \dot{b}ₐ(t) represents a time rate of change of the zero-bias error vector of a tri-axis accelerometer, \dot{b}_{g}(t) represents a time rate of change of the zero-bias error vector of the tri-axis gyroscope.

A continuous time system noise vector and matrix are obtained based on δ\dot{x}(t), which is expressed as follows:

$$\begin{matrix}w ( t ) = {[ {w}_{v}^{T} , {w}_{φ}^{T} , {w}_{gb}^{T} , {w}_{ab}^{T} , {w}_{ga}^{T} , {w}_{a a}^{T} ]}^{T} \\ E [ x ( t ) {w}^{T} ( τ ) ] = q ( t ) δ ( t - τ )\end{matrix}$$

where

$${w}_{v}^{T} and {w}_{φ}^{T}$$

represent measurement white noise of the accelerometer and measurement white noise of the gyroscope, respectively; and

$${w}_{g b}^{T} , {w}_{a b}^{T} , {w}_{g a}^{T} and {w}_{a a}^{T}$$

represent driving white noise of a modeled zero-bias error vector of the tri-axis gyroscope, driving white noise of a modeled zero-bias error vector of the tri-axis accelerometer, driving white noise of a modeled error vector of the scale factor of the gyroscope, and driving white noise of a modeled error vector of the scale factor of the accelerometer.

A state equation of a discretized system is obtained based on using a basic equation of a discrete-time Kalman filter, which is expressed as follows:

$$δ {x}_{k} = {Φ}_{k / k - 1} δ {x}_{k - 1} + {w}_{k - 1}$$

$$where$$

$${Φ}_{k / k - 1} = exp ( {\int }_{{t}_{k - 1}}^{{t}_{k}} F ( t ) d t )$$

$${w}_{k - 1} = {\int }_{{t}_{k - 1}}^{{t}_{k}} {Φ}_{k / t} G ( t ) w ( t ) d t$$

where δxₖ=Φ_{k/k-1}δxₖ₋₁+wₖ₋₁ represents discretizing δ\dot{x}(t)=F(t)δx(t)+G(t)w(t), δxₖ and δxₖ₋₁ represent values of state vectors at time k and time k−1, Φ_{k/k-1} represents a one-step transition matrix of state, wₖ₋₁ represents an equivalent discretization of driving white noise at time

$$k - 1 , exp ( {\int }_{{t}_{k - 1}}^{{t}_{k}} F ( t ) d t )$$

represents an integration of a continuous time system matrix (F(t)) at a time interval of [tₖ₋₁, tₖ] and taking an exponent to obtain the discrete state transition matrix,

$${\int }_{{t}_{k - 1}}^{{t}_{k}} {Φ}_{k / t} G ( t ) w ( t ) d t$$

represents an integration of continuous process noise w(t) based on the noise driving matrix G(t) and transition matrix Φ_{k/t}.

The discretized system meets requirements of the basic equation of the discrete time Kalman filter, and the discretized system is configured to solve a global navigation satellite system and inertial measurement unit (GNSS/IMU) integrated navigation problem; the discretized system is configured to perform filtering on sequential data from the GNSS including latitude lat and longitude lon, data from the IMU including angular velocities of ωₓ, ω_{y} and ω_{z} and accelerations of aₓ, a_{y} and a_{z} along x, y, and z axes of each human-driven vehicle, respectively; and the discretized system is configured to output data of each human-driven vehicle to the CAVs.

Specifically, the sensing method includes steps as follows.

YOLOv5 is used to achieve target detection of the surrounding environment for the human-driven vehicles, and if the collaborative sensing application of the vehicle is activated, raw sensing data (camera RGB images, 3D LiDAR points) and processed sensing data (detected obstacles, calibrated vehicle position) will be transmitted to the CAVs nearby the human-driven vehicle through the V2X communication module, thereby achieving collaborative sensing of the CAVs.

Specifically, the planning method includes steps as follows.

An optimal global planning path is created according to a start point and an end point of each human-driven vehicle by using an A* algorithm with a Euclidean distance as a heuristic algorithm. Then, during driving of each human-driven vehicles, a smooth local planning path of each human-driven vehicle is generated by using a cubic spline interpolation, the smooth local planning path includes a list of x and y coordinates of returning path, a list of curvatures of the returning path, and a list of yaw angles of the returning path, is generated for each human-driven vehicle by using a cubic spline interpolation. After the generating, the lists of the returning path are transmitted to a control end to create commands of braking, acceleration, and steering.

A calculation formula of the Euclidean distance D is expressed as follows:

$$D = \sqrt{( {x}_{1}^{2} - {x}_{2}^{2} ) + ( {y}_{1}^{2} - {y}_{2}^{2} )}$$

where x and y represent corresponding two-dimensional coordinates, and the optimal global planning path is achieved by inputting the start point and the end point of each vehicle.

During the driving of the vehicle, the cubic spline interpolation is used to generate the smooth local path. First, the distances between interpolation points are calculated. Then, based on data of the positioning module, a current position and a yaw angle of the vehicle are obtained, and the corresponding x and y coordinates information of the corresponding waypoint based on the current location. Finally, the difference h[i] and slope s[i] for each subinterval are calculated.

$$\begin{matrix}h [ i ] = x [ i + 1 ] - x [ i ] \\ s [ i ] = \frac{y [ i + 1 ] - y [ i ]}{h [ i ]}\end{matrix}$$

where [i] represents a certain time i, [i+1] represents a certain time i+1, x[i+1] represents an x-coordinate of the vehicle at the time i+1, x[i] represents an x-coordinate of the vehicle at the time i, y[i] represents a y-coordinate of the vehicle at the time i, and y[i+1] represents a y-coordinate of the vehicle at the time i+1.

The cubic polynomial coefficients a[i], b[i], c[i], and d[i] on each subinterval are solved.

$$\begin{matrix}a [ i ] = y [ i ] \\ b [ i ] = s [ i ] \\ c [ i ] = \frac{1}{h [ i ]} [ \frac{3 * ( y [ i + 1 ] - y [ i ] )}{h [ i ]} - 2 * s [ i ] - s [ i + 1 ] ] \\ d [ i ] = \frac{1}{{h [ i ]}^{2}} [ \frac{2 * ( y [ i ] - y [ i + 1 ] )}{h [ i ]} + s [ i ] + s [ i + 1 ] ]\end{matrix}$$

where [i], b[i], c[i], and d[i] represent a baseline value of a cubic spline function at a node i, a first derivative correlation coefficient at the node i, a second derivative correlation coefficient at the node i, and a third derivative correlation coefficient at the node i, respectively.

For each subinterval (x[k], x[k+1]), an equation is created to calculate the interpolation result:

$$y = a [ k ] + b [ k ] * ( x - x [ k ] ) + c [ k ] * {( x - x [ k ] )}^{2} + d [ k ] * {( x - x [ k ] )}^{3}$$

A curvature formula for a certain point on a path is obtained by solving the geometric properties of the path, as follows:

$$k = \frac{{y}^{″} * {x}^{′} - {x}^{″} * {y}^{′}}{{( {x}^{′2} + {y}^{′2} )}^{\frac{3}{2}}}$$

where y′ and y″ respectively represent a first derivative and a second derivative of the path in a y direction; x′ and x″ respectively represent a first derivative and a second derivative of the path in a x direction; a numerator of y″*x′−x″*y′ represents a projection of a path tangent on an x-y plane, and a denominator of

$${( {x}^{′2} + {y}^{′2} )}^{\frac{3}{2}}$$

represents a length of the path tangent on the x-y plane.

A formula used to calculate the yaw angle (Yaw) is as follows:

$$yaw = arc tan ( \frac{{y}^{′}}{{x}^{′}} )$$

where y′ represents a first derivative of the path in the y direction, and x′ represents a first derivative of the path in the x direction. The yaw angle of the path is calculated based on a ratio of the slopes using an arctangent function. Detailed information about the shape and direction of the path curve are obtained.

Finally, a smooth local planning path including a list of x and y coordinates of returning path, a list of curvatures of the returning path, and a list of yaw angles of the returning path, is generated. After the generating, the lists of the returning path are transmitted to a control end to create commands of braking, acceleration, and steering.

Specifically, the control method includes steps as follows.

Possible disturbances during movements of the human-driven vehicles are compensated by using an MPC. By solving for the optimal control of each control unit within the prediction horizon, and selecting the control inputs within the control horizon, rolling optimization is performed until the end of the last time window. The overall framework is shown in FIG. 8.

An observation matrix of the system is expressed as:

$$x ( k + 1 ) = A x ( k ) + B u ( k )$$

where

$$x ( k ) = {χ}_{i} ( k ) , \qquad u ( k ) = {a}_{i} ( k ) , \qquad A = [ \begin{matrix}1 & Δ t \\ 0 & 1\end{matrix} ] , \qquad B = [ \begin{matrix}\frac{1}{2} Δ {t}^{2} \\ Δ t\end{matrix} ] ,$$

and Δt represents a time step.

At a time k, x(k) is taken as an initial state of the system, the above equation can predict the state of the system from time k+1 to k+N.

$${X}_{k} = ( \begin{matrix}x ( k + 1 \vert k ) \\ x ( k + 2 \vert k ) \\ … \\ x ( k + N \vert k )\end{matrix} ) , {U}_{k} = ( \begin{matrix}u ( k ) \\ u ( k + 1 ) \\ … \\ u ( k + N - 1 )\end{matrix} )$$

where x(k+1) represents a state vector of the system at time k+1, x(k) represents a state vector of the system at time k, A represents a transition matrix, B represents an input matrix, u(k) represents an input vector of the system at time k, χᵢ(k) represents a position, and aᵢ(k) represents an acceleration.

According to the observation matrix of the system, following equations can be obtained.

$${X}_{k} = M * x ( k ) + C * u ( k )$$

$$M = ( \begin{matrix}A \\ {A}^{2} \\ … \\ {A}^{N}\end{matrix} ) , C = ( \begin{matrix}B & 0 & … & 0 \\ A B & B & … & 0 \\ … & … & … & … \\ {A}^{N - 1} B & {A}^{N - 2} B & … & B\end{matrix} )$$

where M represents a mapping matrix composed of powers of matrix

$$( \begin{matrix}A \\ {A}^{2} \\ … \\ {A}^{N}\end{matrix} ) ,$$

which maps the original state x(k) to an extended state space, C represents a special structure matrix, which is composed of combination terms A and B and is configured to characterize the influence of u(k) on the extended state Xₖ.

The system constraints defined are as follows:

$${v}_{min} \leq v ( k ) \leq {v}_{max}$$

$${a}_{min} \leq u ( k ) \leq {a}_{max}$$

where vₘᵢₙ and vₘₐₓ represent minimum and maximum constraint values of velocity in the system state, respectively, and aₘᵢₙ and aₘₐₓ represent constraint values of acceleration, respectively.

Afterwards, the optimization problem will be transformed into the standard form of quadratic programming, with the objective function defined as follows:

$$min {\sum }_{k = 1}^{N} \{ {( {X}_{k} - {R}_{k} )}^{T} Q ( {X}_{k} - {R}_{k} ) + {u}_{k}^{T} R {u}_{k} \}$$

where Rₖ represents the reference trajectory, Q and R represent weight matrices, with the first term representing a tracking error and the second term representing an energy value.

Simultaneously, during the operation of CAVs, an equal vehicle headway control model is adopted, as follows:

$$p o {s}_{j}^{t} = \frac{p o {s}_{j - 1}^{t} - {L}_{j - 1} + p o {s}_{j}^{t - Δ t} * gap / Δ t}{1 + gap / Δ t}$$

$${v}_{j}^{t} = \frac{‖ {pos}_{j}^{t} - {pos}_{j}^{t - Δ t} ‖}{Δ t}$$

where

$$p o {s}_{j}^{t} and {pos}_{j - 1}^{t}$$

represent a position of the vehicle j at time t and a position of its preceding vehicle j−1, respectively; Lⱼ₋₁ represents a length of the preceding vehicle; Δt represents a time step; gap represents an ideal headway;

$${v}_{j}^{t}$$

represents an expected speed of the vehicle j at a time step t.

Values of corresponding throttles, brakes, and steering angle are generated based on information of planning path in real time by using the equal vehicle headway control model.

Specifically, the V2X communication method includes steps as follows.

The current status (i.e., follow, change lanes, queue up) of each human-driven vehicle is transmitted in real time, the CAVs around each human-driven vehicle are communicate with each human-driven vehicle in real-time based on a V2X communication module. Decisions are made at a current time by a decision planning module based on the current status of each human-driven vehicle, and collaborative driving between the human-driven vehicles are carried out.

Moreover, the autonomous driving is achieved in real time through sensing, positioning, planning, control, and V2X communication modules. The virtual environment interacts with the realistic environment in real time, thereby realizing a complete set of autonomous driving development and testing that combines the virtual environment and the realistic environment on the realistic testing site.

In an embodiment, each of the sensing module, the positioning module, the planning module, the control module, the V2X communication module, the equal vehicle headway control model, and the decision planning module is embodied by at least one processor and at least one memory coupled to the at least one processor, and the at least one memory stores computer programs executable by the at least one processor.

The method and the system can add realistic vehicles to enhance the reality of the testing process, set up a full suite of sensing, positioning, planning, control, and V2X communication modules for the CAVs, establish the virtual human-driven vehicles with different driving styles, import the realistic human-driven vehicles operated by the realistic drivers through the driving simulators, significantly reduce the cost and enhance the safety of large scale testing of the realistic vehicles, and achieve the virtual-physical integration dynamics, mixed traffic flow simulation, and various complex virtual traffic scenarios for a more authentic testing environment.

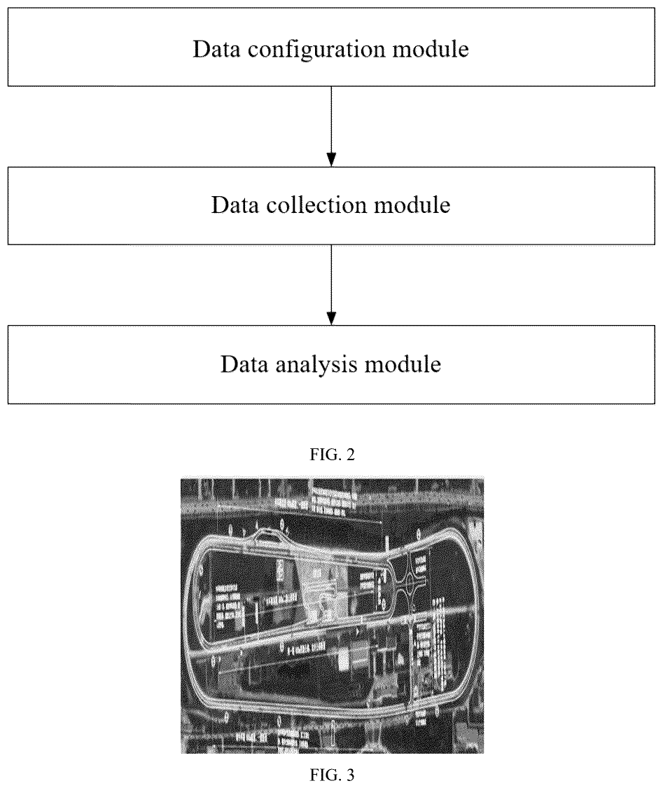

As shown in FIG. 2, which a structural block diagram of a hybrid traffic flow testing system based on the digital twin and the virtual-physical integration of the disclosure.

The hybrid traffic flow testing system includes a data configuration module, a data collection module, and a data analysis module. The data configuration module is configured to collect data of a realistic testing site and create a virtual scene based on the digital twin, and set up interactions between a realistic environment and a virtual environment achieve a system configuration of a system based on the virtual-physical integration. The data collection module is configured to generate virtual human-driven vehicles with different styles based on a data set of the system configuration, and generate realistic human-driven vehicles with different styles based on data collected by driving simulators operated by realistic human drivers; wherein human-driven vehicles with different driving styles are formed by combining a portion of the virtual human-driven vehicles and a portion of the realistic human-driven vehicles, and the data collection module is configured to acquire status information and location information of the human-driven vehicles with different driving styles. The data analysis module is configured to set up a set of sensing, positioning, planning, control, and V2X communication methods for CAVs based on the status information and the location information of the human-driven vehicles with different driving styles, and perform autonomous driving of the CAVs in the system based on the of the set of sensing, positioning, planning, control, and V2X communication methods.

In an embodiment, each of the data configuration module, the data collection module, and the data analysis module is embodied by at least one processor and at least one memory coupled to the at least one processor, and the at least one memory stores computer programs executable by the at least one processor.

Based on the method and the system, the embodiment can add realistic vehicles to enhance the reality of the testing process, set up a full suite of sensing, positioning, planning, control, and V2X communication modules for the CAVs, establish the virtual human-driven vehicles with different driving styles, import the realistic human-driven vehicles operated by the realistic drivers through the driving simulators, significantly reduce the cost and enhance the safety of large scale testing of the realistic vehicles, and achieve the integration of realistic vehicle dynamics, mixed traffic flow simulation, and various complex virtual traffic scenarios for a more authentic testing environment.

The above description is only a preferred embodiment of the disclosure and is not intended to limit the disclosure. Any modifications, equivalent substitutions, improvements, etc. made within the spirit and principles of the disclosure should be included in the scope of protection of the disclosure.

What is claimed is:

1. A hybrid traffic flow testing method based on digital twin and virtual-physical integration, comprising:
collecting data of a realistic testing site and creating a virtual scene based on the digital twin, and setting up interactions between a realistic environment and a virtual environment to achieve a system configuration of a system based on the virtual-physical integration;
generating virtual human-driven vehicles with different styles based on a data set of the system configuration, and generating realistic human-driven vehicles with different styles based on data collected by driving simulators operated by realistic human drivers; forming human-driven vehicles with different driving styles by combining a portion of the virtual human-driven vehicles and a portion of the realistic human-driven vehicles; and acquiring status information and location information of the human-driven vehicles with different driving styles; and
setting up, based on the status information and the location information of the human-driven vehicles with different driving styles, a set of sensing, positioning, planning, control, and vehicle to everything (V2X) communication methods for connected and automated vehicles (CAVs), and performing autonomous driving of the CAVs in the system based on the of the set of sensing, positioning, planning, control, and V2X communication methods.

2. The hybrid traffic flow testing method based on the digital twin and the virtual-physical integration as claimed in claim 1, wherein the collecting data of a realistic testing site and creating a virtual scene based on the digital twin, and setting up interactions between a realistic environment and a virtual environment to achieve a system configuration based on the virtual-physical integration comprises:
collecting the data of the realistic testing site from a realistic autonomous driving test site, constructing a point cloud map of the realistic testing site, and creating a three-dimensional (3D) reconstructed scene and completing a basic construction of the virtual environment based on the digital twin; importing appearances, physical models, and skeletons of realistic vehicles into the virtual environment, generating a mapping of the realistic vehicles in the virtual environment, updating a state of the realistic vehicles in the virtual environment by transmitting data of status information and control information of the realistic vehicles in the realistic environment to the virtual environment, and modeling the CAVs and synchronously transmitting the modeled CAVs to a realistic scene, thereby controlling the realistic vehicles in the realistic scene; and completing an edition of the virtual scene by virtual traffic participants using a testing device based on the virtual-physical integration, and transmitting, by wearable devices, postures of realistic traffic participants wearing the wearable devices in real-time into the system; and
executing by the virtual human-driven vehicles, based on the status information, the control information, and virtual scene information of the realistic vehicles, decision-making, planning, and control functions in the virtual environment; transmitting status information and control information of the virtual human-driven vehicles to a Kafka server based on a data exchange protocol, followed by transmitting the status information and the control information of the virtual human-driven vehicles to the realistic human-driven vehicles through the Kafka server; and executing, by the realistic vehicles, the control information of the virtual human-driven vehicles in the realistic environment.

3. The hybrid traffic flow testing method based on the digital twin and the virtual-physical integration as claimed in claim 1, wherein the generating virtual human-driven vehicles with different styles based on a data set of the system configuration, and generating realistic human-driven vehicles with different styles based on data collected by driving simulators operated by realistic human drivers; forming human-driven vehicles with different driving styles by combining a portion of the virtual human-driven vehicles and a portion of the realistic human-driven vehicles; and acquiring status information and location information of the human-driven vehicles with different driving styles comprises:
performing cleaning and denoising on the data set of the system and the data collected by the driving simulators operated by realistic human drivers to obtain processed data, performing a cluster analysis on the processed data to classify the driving styles into a conservative style, a conventional style, and an aggressive style, and establishing human driver models with the different driving styles; and generating the human-driven vehicles with the different driving styles by using a simulation of urban mobility (SUMO), then using a normal distribution to calibrate parameters for the human-driven vehicles with the different driving styles:
$$f ( x ) = \frac{1}{\sqrt{2 π} σ} exp ( - \frac{{( x - μ )}^{2}}{2 {σ}^{2}} )$$
where μ represents a mathematical expectation, σ² represents a variance, and ƒ(x) represents a normal distribution with obedience parameters of μ and σ;
wherein a state vector X is used to represent parameters that need to be calibrated for the human-driven vehicles with the different driving styles, the different driving styles are classified based on the normal distribution with obedience parameters, to thereby obtain the virtual human-driven vehicles with the different driving styles; a part of realistic vehicles is driven by the realistic human drivers through the simulator to thereby generate the realistic human-driven vehicles, and the virtual human-driven vehicles and the realistic human-driven vehicles together form the human-driven vehicles with the different driving styles under different penetration rates, to thereby obtain the status information and the location information of the human-driven vehicles with the different driving styles.

4. The hybrid traffic flow testing method based on the digital twin and the virtual-physical integration as claimed in claim 1, wherein the positioning method comprises:
defining a state vector of a Kalman filter, wherein the state vector of the Kalman filter comprises navigation state errors and sensor errors, and is expressed as follows:
$$δ x ( t ) = {[ {φ}^{T} , {a}_{a}^{T} , {a}_{g}^{T} , {b}_{a}^{T} , {b}_{g}^{T} , {( δ {r}^{n} )}^{T} , {( δ {v}^{n} )}^{T} ]}^{T}$$
where δx(t) represents the state vector of the Kalman filter, T represents an transpose operation, t represents time, φ represents an error vector of an attitude, aₐ represents an error vector of a scale factor of an accelerometer, a_{g} represents an error vector of a scale factor of a gyroscope, bₐ represents a zero-bias error vector of a tri-axis accelerometer, b_{g} represents a zero-bias error vector of a tri-axis gyroscope, δrⁿ represents an error vector of an inertial navigation position, and
$$δ {v}^{n}$$
represents an error vector of an inertial navigation velocity;
obtaining a continuous time differential equation of the state vector of the Kalman filter, then obtaining error differential equations of a position, a velocity, and an attitude by differentiating vector components of the state vector of the Kalman filter with respect to the time t; performing a first order Gauss-Markov process to model the error vector of the scale factor of the accelerometer, the error vector of the scale factor of the gyroscope, the zero-bias error vector of the tri-axis accelerometer and the zero-bias error vector of the tri-axis gyroscope; and deriving a noise vector and matrix of the system in continuous time from the continuous time differential equation of the state vector of the Kalman filter expressed as follows:
$$w ( t ) = {[ {w}_{v}^{T} , {w}_{φ}^{T} , {w}_{gb}^{T} , {w}_{ab}^{T} , {w}_{ga}^{T} , {w}_{a a}^{T} ]}^{T}$$
$$E [ x ( t ) {w}^{T} ( τ ) ] = q ( t ) δ ( t - τ )$$
where
$${w}_{v}^{T} and {w}_{φ}^{T}$$
represent measurement white noise of the accelerometer and measurement white noise of the gyroscope, respectively; and
$${w}_{g b}^{T} , {w}_{a b}^{T} , {w}_{g a}^{T} and {w}_{a a}^{T}$$
represent driving white noise of a modeled zero-bias error vector of the tri-axis gyroscope, driving white noise of a modeled zero-bias error vector of the tri-axis accelerometer, driving white noise of a modeled error vector of the scale factor of the gyroscope, and driving white noise of a modeled error vector of the scale factor of the accelerometer;
obtaining a state equation of a discretized system based on a basic equation of a discrete-time Kalman filter, expressed as follows:
$$δ {x}_{k} = {Φ}_{k / k - 1} δ {x}_{k - 1} + {w}_{k - 1}$$
$$where$$
$${Φ}_{k / k - 1} = exp ( {\int }_{{t}_{k - 1}}^{{t}_{k}} F ( t ) dt )$$
$${w}_{k - 1} = {\int }_{{t}_{k - 1}}^{{t}_{k}} {Φ}_{k / t} G ( t ) w ( t ) dt$$
wherein the discretized system meets requirements of the basic equation of the discrete time Kalman filter, and the discretized system is configured to solve a global navigation satellite system and inertial measurement unit (GNSS/IMU) integrated navigation problem; the discretized system is configured to perform filtering on sequential data from the GNSS including latitude lat and longitude lon, data from the IMU including angular velocities of ωₓ, ω_{y} and ω_{z} and accelerations of aₓ, a_{y} and a_{z} along x, y, and z axes of each human-driven vehicle, respectively; and the discretized system is configured to output data of each human-driven vehicle to the CAVs.

5. The hybrid traffic flow testing method based on the digital twin and the virtual-physical integration as claimed in claim 1, wherein the sensing method comprises:
detecting objects in a surrounding of each human-driven vehicle by using a you only look once version 5 (YOLOv5); in response to a collaborative sensing application of each human-driven vehicle being activated, sending, through a V2X communication module, both raw sensing data and processed sensing data to the CAVs nearby the human-driven vehicle, thereby achieving collaborative sensing of the CAVs.

6. The hybrid traffic flow testing method based on the digital twin and the virtual-physical integration as claimed in claim 1, wherein the planning method comprises:
creating an optimal global planning path according to a start point and an end point of each human-driven vehicle by using an A* algorithm with an Euclidean distance as a heuristic algorithm; during driving of each human-driven vehicle, generating a smooth local planning path of each human-driven vehicle by using a cubic spline interpolation, the smooth local planning path comprises a list of x and y coordinates of returning path, a list of curvatures of the returning path, and a list of yaw angles of the returning path; and transmitting the lists of the returning path to a control end to create commands of braking, acceleration, and steering.

7. The hybrid traffic flow testing method based on the digital twin and the virtual-physical integration as claimed in claim 1, wherein the control method comprises:
compensating disturbances during movements of the human-driven vehicles by using a model predictive control (MPC); and during operations of the CAVs, generating, based on information of planning path in real time, values of throttles, brakes, and steering angles by using an equal vehicle headway control model.

8. The hybrid traffic flow testing method based on the digital twin and the virtual-physical integration as claimed in claim 1, wherein the V2X communication method comprises:
transmitting a current status of each human-driven vehicle in real time, wherein the CAVs around each human-driven vehicle are communicate with each human-driven vehicle in real-time based on a V2X communication module; and
making by a decision planning module, based on the current status of each human-driven vehicle, decisions at a current time, and carrying out collaborative driving between the human-driven vehicles.

9. The hybrid traffic flow testing method based on the digital twin and the virtual-physical integration as claimed in claim 1, wherein the performing autonomous driving of the CAVs in the system comprises:
achieving the autonomous driving in real time through sensing, positioning, planning, control, and V2X communication modules, wherein the virtual environment interacts with the realistic environment in real time, thereby realizing a complete set of autonomous driving development and testing that combines the virtual environment and the realistic environment on the realistic testing site.

10. A hybrid traffic flow testing system based on digital twin and virtual-physical integration, comprising:
a data configuration module, configured to collect data of a realistic testing site and create a virtual scene based on the digital twin, and set up interactions between a realistic environment and a virtual environment achieve a system configuration of a system based on the virtual-physical integration;
a data collection module, configured to generate virtual human-driven vehicles with different styles based on a data set of the system configuration, and generate realistic human-driven vehicles with different styles based on data collected by driving simulators operated by realistic human drivers; wherein human-driven vehicles with different driving styles are formed by combining a portion of the virtual human-driven vehicles and a portion of the realistic human-driven vehicles, and the data collection module is configured to acquire status information and location information of the human-driven vehicles with different driving styles; and
a data analysis module, configured to set up a set of sensing, positioning, planning, control, and V2X communication methods for CAVs based on the status information and the location information of the human-driven vehicles with different driving styles, and perform autonomous driving of the CAVs in the system based on the of the set of sensing, positioning, planning, control, and V2X communication methods.
